(19) United States
(12) Patent Application Publication
(10) Pub. No.: US 2024/0338190 A1
(43) Pub. Date: Oct. 10, 2024

(54) Methods and Systems for Remote Installation of Computer Software and Monitoring Progress of the Installation on a Local Computing Entity

(71) Applicant: IDEXX Laboratories, Inc., Westbrook, ME (US)

(72) Inventors: Benjamin Ulwelling, Westbrook, ME (US); Daniel Sparks, Westbrook, ME (US); Aaron Cristaldi, Westbrook, ME (US); Brett Tirrell, Westbrook, ME (US); Alexandra Guitard, Westbrook, ME (US)

(21) Appl. No.: 18/627,865

(22) Filed: Apr. 5, 2024

Related U.S. Application Data
(60) Provisional application No. 63/494,804, filed on Apr. 7, 2023.

(51) Int. Cl. G06F 8/61; G06F 8/41; G06F 11/14; G06F 11/32

(52) U.S. Cl. CPC G06F 8/61; G06F 8/433; G06F 11/1433; G06F 11/1438; G06F 11/327; G06F 11/328

(57) ABSTRACT

An example computer implemented method includes sending a first data package from a central computing entity to a local computing entity that includes (1) dependency check instructions and (2) partition instructions. The local computing entity executes the instructions to determine runtime dependencies, divide a memory into a first partition and a second partition, and move an existing operating system instruction set and user data to the first partition of the memory. The method further includes receiving a confirmation signal at the central computing entity indicative of the runtime dependencies and that the local computing entity formed the partitions in the memory, and subsequently sending a second data package to install a second operating system instruction set on the local computing entity. Following, the method includes monitoring progress of installation of the second operating system instruction set on the local computing entity.

### CROSS REFERENCE TO RELATED APPLICATION

The present disclosure claims priority to U.S. Application No. 63/494,804, filed on Apr. 7, 2023, the entire contents of which are herein incorporated by reference.

### FIELD

The present disclosure relates generally to methods and systems for remotely installing computer software, and more particularly to remotely controlling installation processes and monitoring progress of installation on the local computing entity.

### BACKGROUND

Procedures for updating computer software for a large number of computers in a remote manner over a network typically involve a series of downloading updates, installing updates, and rebooting the computers through a series of automated cycles that continue the download/install/reboot cycle until no more updates are found to install. Data from the computers is backed up on the cloud during the updating process in which an owner of the computer lacks control over the data at that time.

### SUMMARY

In an example, a computer implemented method is described comprising sending a first data package from a central computing entity to a local computing entity, and the first data package comprises first instructions comprising (1) dependency check instructions and (2) partition instructions, and wherein the first instructions, when executed by a processor of the local computing entity, cause the processor to: determine runtime dependencies of the local computing entity; divide a memory of the local computing entity into a first partition and a second partition; and move an existing operating system instruction set and user data to the first partition of the memory. The method further comprises receiving a confirmation signal at the central computing entity indicative of the runtime dependencies of the local computing entity and that the local computing entity comprises the first partition and the second partition in the memory, subsequent to receiving the confirmation signal, sending to the local computing entity a second data package comprising second instructions executable to install a second operating system instruction set on the local computing entity, and monitoring, at the central computing entity, progress of installation of the second operating system instruction set on the local computing entity.

In another example, a computer implemented method is described comprising receiving at a local computing entity a first data package from a central computing entity, and the first data package comprises first instructions comprising (1) dependency check instructions and (2) partition instructions. The method also comprises executing the first instructions by a processor of the local computing entity to: determine runtime dependencies of the local computing entity; divide a memory of the local computing entity into a first partition and a second partition; and move an existing operating system instruction set and user data to the first partition of the memory. The method also comprises sending a confirmation signal to the central computing entity indicative of the runtime dependencies of the local computing entity and that the local computing entity comprises the first partition and the second partition in the memory, subsequent to sending the confirmation signal, receiving at the local computing entity a second data package comprising second instructions comprising (1) installation instructions and (2) a second operating system instruction set, executing, by the processor of the local computing entity, the installation instructions to cause installation of the second operating system instruction set on the local computing entity, and during the installation of the second operating system instruction set on the local computing entity, sending from the local computing entity to the central computing entity messages indicative of progress of the installation of the second operating system instruction set on the local computing entity.

In another example, a non-transitory computer readable medium is described having stored thereon instructions, that when executed by one or more processors of a local computing entity, cause the local computing entity to perform functions comprising receiving at the local computing entity a first data package from a central computing entity, the first data package comprising first instructions comprising (1) dependency check instructions and (2) partition instructions, executing the first instructions by the processor of the local computing entity to: determine runtime dependencies of the local computing entity; divide a memory of the local computing entity into a first partition and a second partition; and move an existing operating system instruction set and user data to the first partition of the memory, sending a confirmation signal to the central computing entity indicative of the runtime dependencies of the local computing entity and that the local computing entity comprises the first partition and the second partition in the memory, subsequent to sending the confirmation signal, receiving at the local computing entity a second data package comprising second instructions comprising (1) installation instructions and (2) a second operating system instruction set, executing, by the processor of the local computing entity, the installation instructions to cause installation of the second operating system instruction set on the local computing entity, and during the installation of the second operating system instruction set on the local computing entity, sending from the local computing entity to the central computing entity messages indicative of progress of the installation of the second operating system instruction set on the local computing entity.

The features, functions, and advantages that have been discussed can be achieved independently in various examples or may be combined in yet other examples. Further details of the examples can be seen with reference to the following description and drawings.

### BRIEF DESCRIPTION OF THE FIGURES

The illustrative examples as well as a preferred mode of use, further objectives and descriptions thereof, will best be understood by reference to the following detailed description of an illustrative example of the present disclosure when read in conjunction with the accompanying drawings, wherein:

FIG. 1 illustrates an example of a system 100, according to an example implementation;

FIG. 2 illustrates an example of the central computing entity 102 in FIG. 1, according to an example implementation;

FIG. 3 illustrates an example of the local computing entity 106 in FIG. 1, according to an example implementation;

FIG. 4 is workflow diagram of an example process of functionality and messaging performed by components of the system 100 of FIG. 1 to update and/or install computer software on the local computing entity 106, according to an example implementation;

FIG. 5 is a conceptual diagram illustrating partitioning of memory of the local computing entity 106, according to an example implementation;

FIG. 6 is a workflow diagram illustrating execution of installation instructions on the local computing entity as the local computing entity evolves through three stages of process execution, according to an example implementation;

FIG. 7 shows a flowchart of an example of a computer implemented method 200, according to an example implementation; and

FIG. 8 shows a flowchart of another example of a computer implemented method 220, according to an example implementation.

### DETAILED DESCRIPTION

Disclosed examples will now be described more fully hereinafter with reference to the accompanying drawings. Indeed, several different examples may be described and should not be construed as limited to the examples set forth herein. Rather, these examples are described so that this disclosure will be thorough and complete and will fully convey the scope of the disclosure to those skilled in the art.

Within examples described herein, technical solutions are provided to assist with updating and/or installing computer software on one or a group of computing devices. In medical and veterinary applications, computing devices can contain sensitive information, such as patient medical information, analyzer test results, patient personal information, patient financial information, and the like. From time to time, it is necessary to upgrade software on the computing systems, for example to address vulnerabilities, maintain compatibility with other computing systems, and the like. Conventional upgrade procedures can involve temporary transfer of sensitive information to an external device (e.g., the cloud), while the software of the computing device is updated. However, upload of the sensitive information carries risks, such as corruption of the information and exposure of the sensitive information to third parties. To minimize these risks, some users may opt to fully replace the computing device, purchasing a second computing device with the upgraded software and locally transferring the sensitive information from the original computing device to the second computing device. However, the purchase of a new computing device is costly, and the hardware of the original computing device may still be serviceable. Accordingly, a need exists for improved systems and methods for securely updating software on computing devices.

In embodiments, software packages are delivered over a network to the computing devices in a sequentially staged download solution. A first package determines compatibility of the device and creates a partition in memory on the device that is used as a holding area for user data and file system data during the updating or installation, so that all data is maintained on the computing device. No data is sent off the computing device during an installation to reduce loss of data and enable confidentiality of data to be maintained. By maintaining the data on the one or more computing devices (as opposed to transferring the data to an external system, e.g., the cloud), risk of exposure of the sensitive information to a third party and/or loss or degradation of the sensitive information is minimized as compared to conventional update approaches.

An example computer implemented method includes sending a first data package from a central computing entity to a local computing entity that includes (1) dependency check instructions and (2) partition instructions. The local computing entity executes the instructions to determine runtime dependencies, forma partitions in a memory thereby dividing the memory into a first partition and a second partition, and move an existing operating system instruction set and user data to the first partition of the memory. The method further includes receiving a confirmation signal at the central computing entity indicative of the runtime dependencies and that the local computing entity formed the first partition and the second partition in the memory, and subsequently sending a second data package to install a second operating system instruction set on the local computing entity. Following, the method includes monitoring progress of installation of the second operating system instruction set on the local computing entity.

Thus, the sequential transmission of data packages to the local computing device prevents delivery of the new image file until the confirmation signal is received. Sequential transmission of data packages thus divides the update or installation process into phases that may lower failure issues experienced when an entire image file and installation instructions are sent concurrently and run-time dependencies are encountered.

Implementations of this disclosure thus provide technological improvements that are particular to computer technology, for example, those concerning updating, installing, or changing computer software on a local computing entity. Computer-specific technological problems, such as remotely causing execution of software installation in a staged process, can be wholly or partially solved by implementations of this disclosure. For example, implementation of this disclosure allows for the local computing entity to prepare for the updates or installation during a first phase, and if the preparation is successful, a second phase including the full installation is performed. Otherwise, the installation does not occur and the local computing entity continues operation accordingly without attempting an installation when the installation may otherwise cause problems with operation of the local computing entity, for example.

The systems and methods of the present disclosure further address problems particular to computer networks, for example, those concerning remote monitoring of computer software updates or installations for a group of computers. For example, a central computing entity utilizes the staged process to determine which computers of the group of computers are compatible and capable of being updated, and then proceeds to send a suitable software update to each individual computer. Implementations of this disclosure can thus introduce new and efficient improvements in the ways in which software updates and installations are performed with external monitoring to determine whether an erroneous installation is being performed.

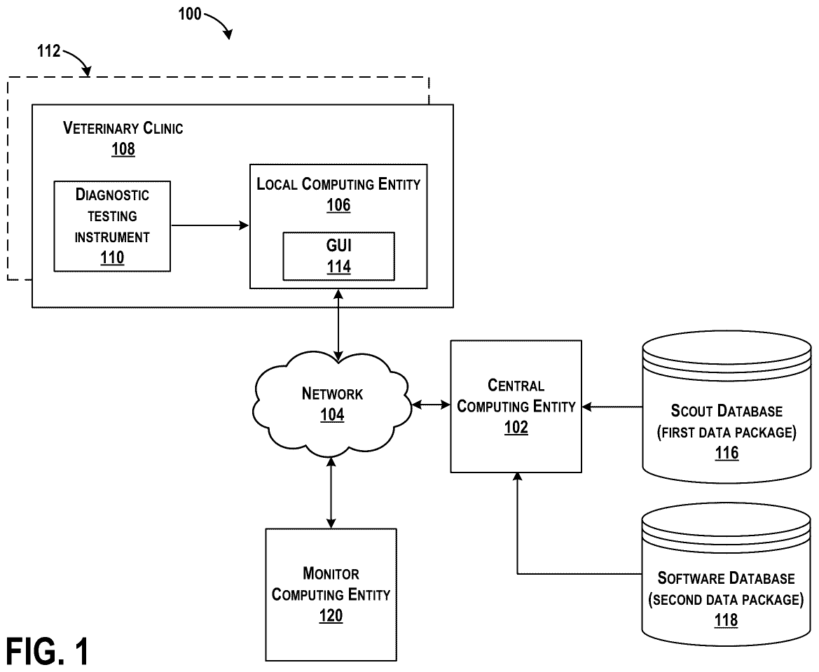

Referring now to the figures, FIG. 1 illustrates an example of a system 100, according to an example implementation. The system 100 includes a central computing entity 102 accessible through a network 104 by multiple different computer systems. In embodiments, one of the computer systems includes a local computing entity 106 residing at a veterinary clinic 108. In embodiments, a diagnostic testing instrument 110 is communicatively coupled to the local computing entity 106, the diagnostic testing instrument 110 operable to perform diagnostic testing of veterinary patients, for example. The diagnostic testing instrument 110 outputs diagnostic test results to the local computing entity 106 for analysis. While one veterinary clinic 108 is depicted in FIG. 1, it should be understood that this is merely an example, and systems according to the present disclosure can include any suitable number of veterinary clinics and associated computer systems, such as a second veterinary clinic 112 that includes the same or similar components as the veterinary clinic 108. As referred to herein, the term “veterinary clinics” includes any entity at which non-human animals receive medical care, and can include brick and mortar locations, mobile clinics, on-line virtual clinics, pop-up clinics, and the like.

In addition, while the example depicted in FIG. 1 includes one diagnostic testing instrument 110, it should be understood that this is merely an example, and embodiments according to the present disclosure can include any suitable number of diagnostic testing instruments associated with the veterinary clinic 108. Examples of the diagnostic testing instrument 110 include any one or combination of veterinary analyzers operable to conduct a diagnostic test of a sample of a patient (e.g., operable to determine hemoglobin amounts in a blood sample, operable to analyze a urine sample, and/or the like). Such veterinary analyzers include, for example and without limitation, a clinical chemistry analyzer, a hematology analyzer, a microscopic analyzer, a urine analyzer, an immunoassay reader, a sediment analyzer, a blood analyzer, a digital radiology machine, and/or the like. In one example, the local computing entity 106 is in communication with a veterinary analyzer of the diagnostic testing instrument 110 and is operable to receive diagnostic information from veterinary analyzer. The diagnostic testing instrument 110 outputs signals, such as signals indicative of diagnostic test results or other information, to the local computing entity 106.

In the system 100, the network 104 (e.g., Internet) provides access to the central computing entity 102 for all network-connected components. In some examples, more components of the system 100 may be in communication with the network 104 to access the central computing entity 102. Communication with the central computing entity 102 and/or with the network 104 may be wired or wireless communication (e.g., some components may be in wired Ethernet communication and others may use Wi-Fi communication). In still further examples, the network 104 provides access for the central computing entity 102 to communicate with the local computing entity 106 directly as well.

The local computing entity 106 includes a graphical user interface (GUI) 114 for display, which in some embodiments is operable to receive input data (e.g., data associated with a subject such as breed, age, etc.). The GUI 114 is thus operable to receive inputs from the local computing entity 106, and to provide an updated display including inquiries received from the central computing entity 102.

The system 100 enables a method for providing a remote imaging utility for use to remotely update or install computer software on computing entities, for example.

The system 100 includes a scout database 116 and a software database 118 to which the central computing entity 102 is in communication for retrieving a first data package and a second data package to send to the local computing entity 106. The first data package is sent from the central computing entity 102 to the local computing entity 106 to determine details of the local computing entity 106 and to prepare the local computing entity 106 for software updates and/or installation. The second data package is then sent from the central computing entity 102 to the local computing entity 106 including instructions for updating or installing software on the local computing entity 106.

The system 100 also includes a monitor computing entity 120 for monitoring progress of installation of the software on the local computing entity 106, for example. In FIG. 1, the monitor computing 120 is illustrates as a separate device. In other examples, functions of the monitor computing entity 120 are performed by the central computing entity 102, and thus, the monitoring computing entity 120 is combined with the central computing entity 102.

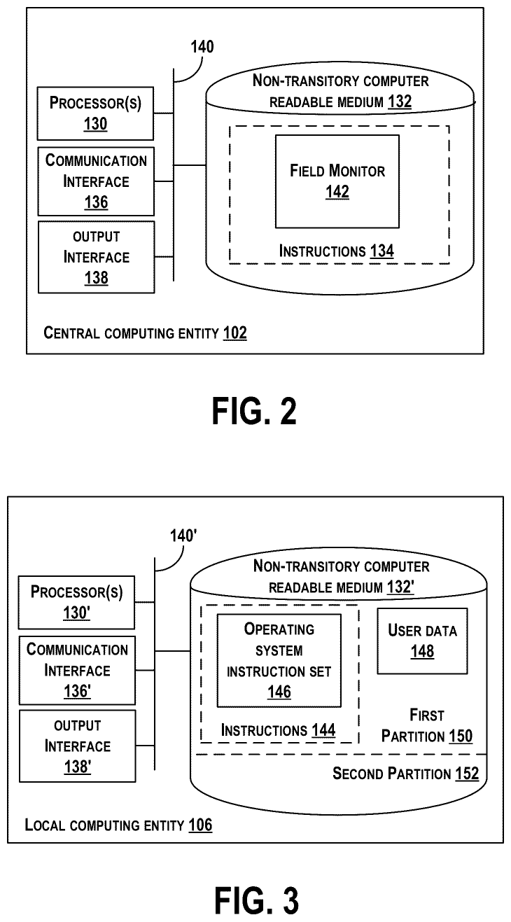

FIG. 2 illustrates an example of the central computing entity 102 in FIG. 1, according to an example implementation. The central computing entity 102 includes one or more processor(s) 130, and non-transitory computer readable medium 132 having stored therein instructions 134 that when executed by the one or more processor(s) 130, causes the central computing entity 102 to perform functions for updating and/or installing computer software on remote computing entities, for example.

To perform these functions, the central computing entity 102 also includes a communication interface 136, an output interface 138, and each component of the central computing entity 102 is connected to a communication bus 140. The central computing entity 102 may also include hardware to enable communication within the central computing entity 102 and between the central computing entity 102 and other devices (not shown). The hardware may include transmitters, receivers, and antennas, for example. The central computing entity 102 may further include a display.

In some embodiments, the communication interface 136 is a wireless interface and/or one or more wireline interfaces that allow for both short-range communication and long-range communication to one or more networks or to one or more remote devices. Such wireless interfaces may provide for communication under one or more wireless communication protocols, Bluetooth, WiFi (e.g., an institute of electrical and electronic engineers (IEEE) 802.11 protocol), Long-Term Evolution (LTE), cellular communications, near-field communication (NFC), and/or other wireless communication protocols. Such wireline interfaces may include an Ethernet interface, a Universal Serial Bus (USB) interface, or similar interface to communicate via a wire, a twisted pair of wires, a coaxial cable, an optical link, a fiber-optic link, or other physical connection to a wireline network. Thus, the communication interface 136 may be configured to receive input data from one or more devices, and may be configured to send output data to other devices.

The non-transitory computer readable medium 132 includes or takes the form of memory, such as one or more computer-readable storage media that can be read or accessed by the one or more processor(s) 130. The non-transitory computer readable medium 132 can include volatile and/or non-volatile storage components, such as optical, magnetic, organic or other memory or disc storage, which can be integrated in whole or in part with the one or more processor(s) 130. In some examples, the non-transitory computer readable medium 132 is implemented using a single physical device (e.g., one optical, magnetic, organic or other memory or disc storage unit), while in other examples, the non-transitory computer readable medium 132 is implemented using two or more physical devices. The non-transitory computer readable medium 132 thus is a computer readable storage, and the instructions 134 are stored thereon. The instructions 134 include computer executable code.

The one or more processor(s) 130 may be general-purpose processors or special purpose processors (e.g., digital signal processors, application specific integrated circuits, etc.). The one or more processor(s) 130 receive inputs from the communication interface 136 (e.g., x-ray images), and process the inputs to generate outputs that are stored in the non-transitory computer readable medium 132. The one or more processor(s) 130 are configured to execute the instructions 134 (e.g., computer-readable program instructions) that are stored in the non-transitory computer readable medium 132 and are executable to provide the functionality of the central computing entity 102 described herein.

The output interface 138 outputs information for transmission, reporting, or storage, and thus, the output interface 138 may be similar to the communication interface 136 and can be a wireless interface (e.g., transmitter) or a wired interface as well.

Within examples, the instructions 134 include specific software for performing the functions including a field monitor 142 to monitor progress of updating or installing computer software on remote computing devices.

FIG. 3 illustrates an example of the local computing entity 106 in FIG. 1, according to an example implementation. Within examples herein, functions described for updating or installing computer software are performed by the central computing entity 102, by the local computing entity 106, or by a combination of the central computing entity 102 and the local computing entity 106. Thus, although FIG. 2 illustrates the central computing entity 102, some components of the local computing entity 106 are substantially similar to or the same as components of the central computing entity 102 within some examples, depending on where a function is programmed to be performed in a specific implementation. As a result, description of components within the local computing entity 106 that are the same as the central computing entity 102 are not repeated here, and such components include the processor 130′, the non-transitory computer readable medium 132′, the communication interface 136′, the output interface 138′, and the communication bus 140′.

Within the non-transitory computer readable medium 132′ of the local computing entity 106, instructions 144 are stored for execution by the processor 130′ to perform functions of an operating system instruction set 146. The operating system instruction set 146, when executed, generates an operating platform with a user interface for a user or device to enter inputs, for example. The non-transitory computer readable medium 132′ of the local computing entity 106 also stores user data 148, which may include program or device settings, outputs from diagnostic testing instruments, patient medical information, patient diagnostic information, billing information, etc. The non-transitory computer readable medium 132′ of the local computing entity 106 is shown to be arranged to have a first partition 150 and a second partition 152. The first partition 150 and the second partition 152 are divisions of the non-transitory computer readable medium 132′ of the local computing entity 106 into sections for use by resident programs. More or fewer partitions can be included in the non-transitory computer readable medium 132 of the local computing entity 106.

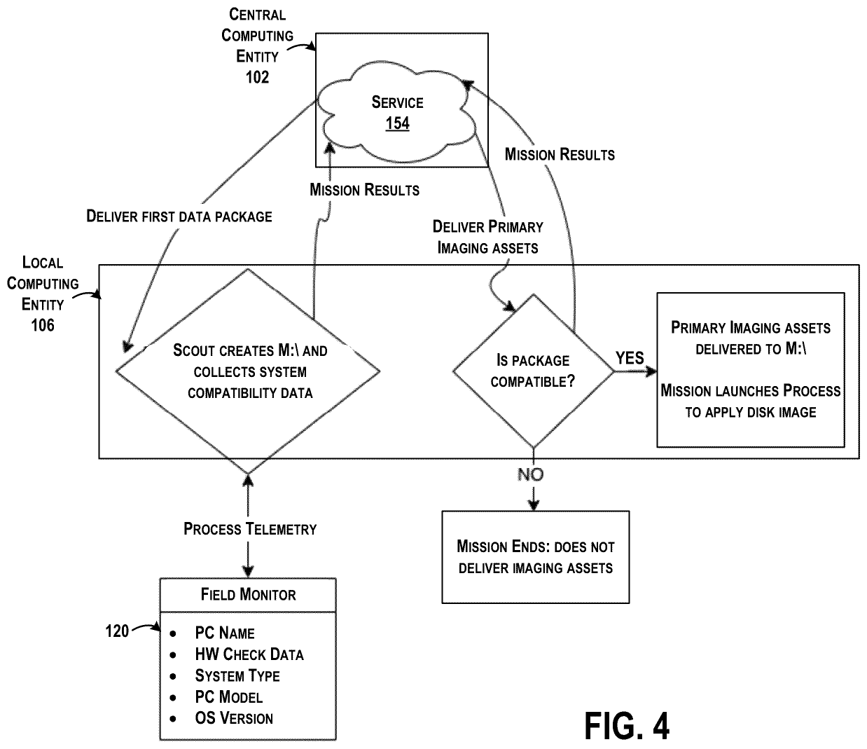

FIG. 4 is workflow diagram of an example process of functionality and messaging performed by components of the system 100 of FIG. 1 to update and/or install computer software on the local computing entity 106, according to an example implementation.

Initially, the central computing entity 102 executes a service program 154 acting as a sole agent for secure delivery of imaging assets. The agent will interact with a service web service over the network 104 (FIG. 1), for example, to receive instructions for the download of three independent payloads or data packages. Each download or sending of a data package occurs in a serial manner and is launched only upon success of its predecessor. Each payload or data package will be downloaded and sent over a secure connection, and its associated software process started by the service agent. No user interaction will be required at any point in the succession of service mission deliveries, nor will there be a visible indication of the delivery processes.

The central computing entity 102 begins the process by sending a first data package from the central computing entity 102 to the local computing entity 106, and the first data package is retrieved from the scout database 116 (FIG. 1). The first data package includes first instructions for (1) dependency check instructions and (2) partition instructions. The first data package is referred to herein as “Scout.” Upon receipt by the local computing entity 106, the processor 130 of the local computing entity executes Scout to determine runtime dependencies of the local computing entity 106, form a partition in a memory of the local computing entity 106 thereby dividing the memory into the first partition 150 and the second partition 152, and move an existing operating system instruction set and user data to the first partition 150 of the memory.

The runtime dependency check is executed to identify presence of runtime dependencies or software classes requiring use of other classes or interface, such as the appropriate. NET Framework version, for example. The runtime dependency check identifies couplings between software classes in use on the local computing entity 106 that may prohibit updating or installing computer software until the runtime dependencies are complete.

The Scout program, in embodiments, deploys a .NET console application that performs a variety of computer system health checks, such as determining hard disk availability and compatibility (e.g., a state of the disk including determining un-writeable disk sectors). In one example, computer system health checks also include checking event logs.

Thus, within examples, executing the Scout program received from the central computing entity 102, which triggers the processor of the local computing entity 106 to execute functions for performing system checks and creating a new partition in local memory requires more than routine computer operation by the existing operating system. In one example, the Scout program enables the central computing entity 102 to control how a subsequent software update or installation will occur on the local computing entity 106 by preparing memory of the local computing entity 106 accordingly.

When the local computing entity 106 is determined to be in good health for the system update, the Scout program is executed to create a new partition in memory (e.g., a logical partition on a physical memory), such as to create a new 25 GB hard disk partition (e.g., M: \ drive) as swap space that will persist during the imaging process. The Scout program uses diskpart functions of the existing operating system, for example, to create the new hard disk partition. After execution of the Scout program, the local computing entity 106 sends a confirmation signal to the central computing entity 102 indicative of the runtime dependencies of the local computing entity 106 and that the local computing entity 106 has created the partition in the memory.

In embodiments, the confirmation signal (e.g., mission results shown in FIG. 4) also indicates details of a compatibility check of the local computing entity 106, such as a type of computer for example, a hardware viability of the local computing entity 106 to identify any defects and check event logs, or other compatibility data.

Subsequent to receiving the confirmation signal, the central computing entity 102 sends to the local computing entity 106 a second data package retrieved from the software database 118 (FIG. 1) that includes instructions executable to install a second operating system instruction set on the local computing entity 106. The central computing entity 102 selects the installation instructions from a group of installation instructions (e.g., within the software database 118) based on the type of the local computing entity 106 to provide a compatible type of installation instructions. Thus, the service program 154 will deliver primary imaging assets including for example, a disk image file (.WIM) and a remote imaging utility's software application suite, to the local computing entity 106.

The primary imaging assets include an application programming interface (API) for BIOS (basic input/output system) of the type of the local computing entity 106. When the local computing entity 106 is powered on, BIOS code runs to initialize and test hardware components, and the BIOS acts as an insulation layer between hardware and software of the local computing entity 106, by providing an interface between the application program/operating system and the hardware devices. The primary imaging assets include appropriate BIOS updates specific for the local computing entity 106.

The primary imaging assets are stored on the newly created partition (e.g., M: \ drive) including both the imaging platform (software executed to perform imaging process) and payload (software image itself).

Once received, the local computing entity 106 executes the remote imaging utility to perform a backup of user data (e.g., customer's profile and workspace data) to the swap space partition (e.g., the M: \ drive). Using the local partition for data backup allows sensitive data to remain on the local computing entity 106 throughout the entire imaging process, rather than exposing any sensitive data (e.g., patient data) to external cloud storage systems. The newly created partition is also a location for storage of the second operating system instruction set (e.g., disk image file) on the local computing entity 106. Backup of data on the newly created partition also provides a data loss prevention mechanism, such that if an error occurs during software changes, copies of data are available.

In the event that the primary imaging assets of the disk image file are found to be incompatible with the local computing entity 106, the primary imaging assets are not delivered to or stored on the newly created partition (e.g., M: \ drive) and the mission ends. In one example, compatible requirement checks include determining that the local computing entity 106 includes appropriate .NET framework dependencies installed. In a Linux or other non-Windows environment, this would be a check for Java version, or other similar platform dependencies. Generally, the local computing entity 106 is required to be identifiable as having an appropriate target configuration for an intended deployment (e.g., a specific image for a type of computer matches to a type of the local computing entity 106).

Within examples, among the imaging assets delivered via the service program 154 will be a highly customized disk image file (.WIM) file. Once received, and the backup is completed, the remote imaging utility will be executed by the local computing entity 106 to cause the remote imaging utility's main process to apply the disk image file currently stored on the M: \ drive partition of the local computing entity 106 to overwrite an existing operating system (OS) installation. The remote imaging utility will first prompt a user of the local computing entity 106 to proceed, and after receiving confirmation input from the user to proceed, the local computing entity 106 is unavailable for use during the updating or software installation.

During the image overwrite application, and any configuration steps taken thereafter, live telemetry of progress and status will be securely streamed to the field monitor 120 for cloud storage to allow visibility into a state of the local computing entity 106 during the operating system transition. Information streamed to the field monitor 120 includes a name of the local computing entity 106, hardware check data, system type data, a computer model, and an existing OS version, for example.

Once the disk image file is applied to the local computing entity 106, the new operating system is bootable. At this time, user data that was backed up to the swap space partition (e.g., the M: \ drive) will be restored to the new operating system. This may include user account information, security settings, databases, and system group policy settings, for example. Thus, after completion of the installation of the second operating system instruction set on the local computing entity 106, the remote imaging utility is executed to move the user data out of the swap space partition and the partition is removed from the memory. In addition, the remote imaging utility is executed to erase the existing operating system instruction set from the memory of the local computing entity 106.

In the workflow shown in FIG. 4, if the central computing entity 102 does not receive the confirmation signal, or if the confirmation signal indicates that the local computing entity 106 did not pass health checks (e.g., lacks available memory, partition not successfully created, etc.), then the central computing entity 102 does not send the second data package to the local computing entity 106. Using this sequential or staged download of the Scout program followed by the remote imaging utility and image file enables the central computing entity 102 to cause the local computing entity 106 to be prepared for the software update or installation prior to sending the installation and image file.

Thus, the central computing entity 102 maintains control of whether the local computing entity 106 will be granted the software update or installation. In contrast to conventional software update techniques where an entire software image file package is transferred to a computing entity for installation, the central computing entity 102 performs an unconventional staged transfer of data packages to the local computing entity 106 to first prepare the local computing entity 106 for installation, and then to cause a new image file to be installed.

Additional advantages result from the staged transfer of data packages, such as, enabling the central computing entity 102 to remotely control and govern the software update or installation on the local computing entity 106, for example.

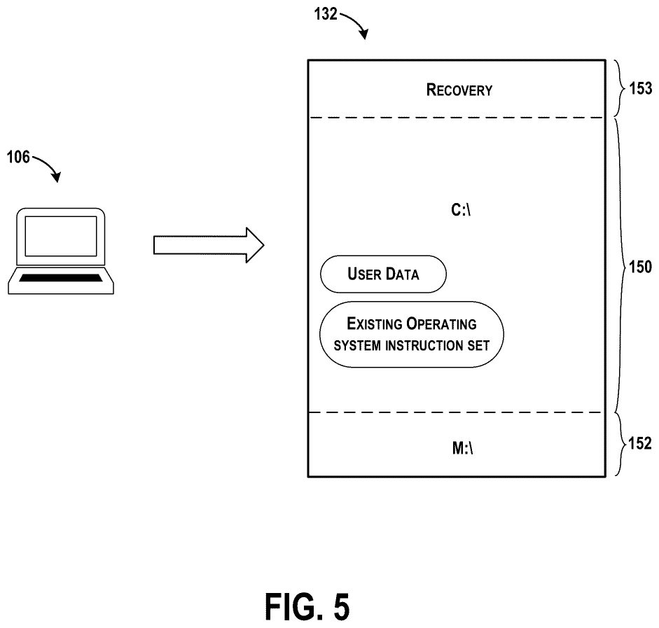

FIG. 5 is a conceptual diagram illustrating partitioning of memory of the local computing entity 106, according to an example implementation. The non-transitory computer readable medium 132 initially includes partitions 150 and 153 that are used for a traditional C:/drive and data recovery storage. The data recovery partition 153 stores data necessary for a backup to restore system data, for example.

An existing operating system instruction set and user data are stored on the partition 150. The Scout program is responsible for creating and configuring the partition 152 (e.g., M: \ drive) where the remote imaging utility and second operating system instructions set are delivered and executed. In addition, a selection of file system data (based on end state requirements) including user data is transferred from the partition 150 to the partition 152 (e.g., from C: \ transferred to M: \) during the updating or installation process. Following, all data not transferred and stored on M: \ is deleted during the process. After installation, a restoration process is executed to return data back to the partition 150 (e.g., C: \ drive) and bring the local computing entity 106 to a functional state, with any unique customer configurations, and the partition 152 is maintained for future use, and all assets deployed to the system for the purposes of the RI process will be removed.

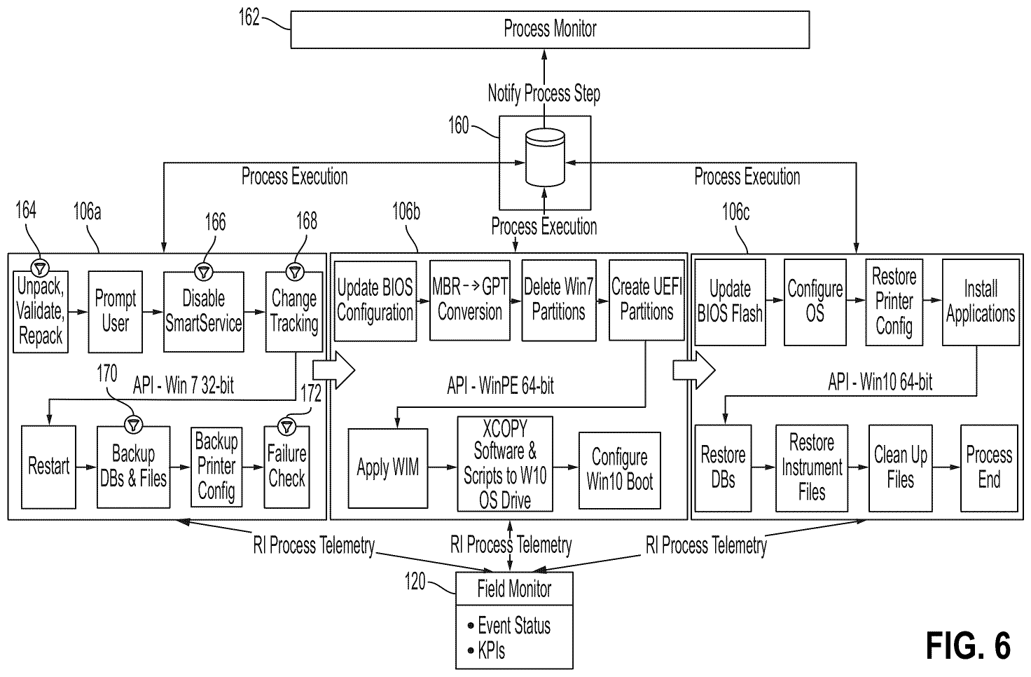

FIG. 6 is a workflow diagram illustrating execution of installation instructions on the local computing entity 106 as the local computing entity 106 evolves through three stages of process execution, according to an example implementation. In FIG. 6, a first stage 106a of process execution, a second stage 106b of process execution, and a third stage 106c of process execution are shown. For example, an asset pack for the local computing entity 106 at the first stage 106a includes details to update an existing Win 7 32-bit operating system, an asset pack for the local computing entity 106 at the second stage 106b includes details to update an existing WinPE 64-bit operating system, and an asset pack for the local computing entity 106 at the third stage 106c includes details for updating an existing Win10 64-bit operating system.

In FIG. 6, a remote imaging utility 160 is represented and controlling process execution for installation of image files on the local computing entity 106. The remote imaging utility 160 generates a process monitor 162 on the local computing entity 106 that is a user interface, per system requirements, to receive inputs to proceed with installation and provide updates to the user of progress of the installation.

In one example, at the first stage 106a, the remote imaging utility 160 causes installation of an image file to update the operating system from a Win 7 32-bit version. In another example, at the second stage 106b, the remote imaging utility 160 causes installation of an image file to update the operating system from a WinPE 64-bit version. In another example, at the third stage 106c, the remote imaging utility 160 causes installation of an image file to update the operating system from a Win10 64-bit version.

In FIG. 6, the local computing entity 106 sends remote imaging (RI) process telemetry messages to the field monitor 120 during the installation of the new operating system instruction set on the local computing entity 106. The messages indicate a progress of the installation of the operating system instruction set on the local computing entity, and can include a failure message, a process execution delay message, or a status message with details of key performance indicators (KPIs).

The RI process telemetry messages thus include live feedback from the local computing entity 106 sent over a secure connection to the field monitor 120 in packets of play-by-play updates (hence, “telemetry”) about success and status of the imaging routine. The data includes what steps have succeeded, what steps have encountered unexpected results or have failed, and includes limited log information to gather statistics on timing, configurations encountered, and other technical detail to be consumed for troubleshooting. The data does not include privileged or sensitive customer information.

In one example, when a failure message is received, the field monitor 120 notifies the central computing entity 102, which sends a recovery instruction package from the central computing entity 102 to the local computing entity 106 executable by the local computing entity 106 to return the local computing entity 106 back to the existing operating system instruction set. In other examples, a failure message received by the central computing entity 102 is designed to be information only and is logged, reviewed, and aggregated into performance metrics. The local computing entity 106 already has all assets and application logic necessary to revert the system state to the original configuration, should that be deemed necessary.

In another example, when a process execution delay message is received, the field monitor 120 flags the deviation for review.

In still another example, when a lack of receipt of any messages from the local computing entity 102 is determined (or a lack of receipt of messages at the field monitor over a predetermined period of time, such as over a 5 minute time interval), the field monitor 120 flags the systems as a potential failure for troubleshooting purposes.

Failures of installation can occur in a number of instances, such as in a scenario of a loss of power (e.g., AC power) to the local computing entity 106. If the field monitor 120 is expecting a regular cadence (e.g., heartbeat) of status messages from the local computing entity 106 and messages are lost or missing, then the field monitor 120 can flag the system for review and/or troubleshooting.

Messages received by the field monitor 120 are logged per machine and aggregated into a database. The data can be used for KPI reporting, monitoring of execution, communication internally, and log analysis to improve future software installations.

In some examples, during installation of the image file, when messages sent to the field monitor 120 indicate a failure, the field monitor 120 flags the system for review and/or troubleshooting. If the failure occurs at a process recovery point of installation, the local computing entity 106 is returned back to an original or existing operating system state. Example process recovery points 164, 166, 168, 170, and 172 are shown in the image file installation of the local computing entity 106a in FIG. 6. Such process recovery points include at initiation (e.g., unpack, validate, repack), upon disable of the service program 154, at change tracking, following backup of database and files, and at a final failure check.

Example recovery processes are wholly contained on the local computing device 106. There is no cooperation or dependence with any other computing entity involved. When a recovery is initiated, any configuration changes and file system changes made to the local computing device 106 will be reversed, and the system returned to the state in which it was found to be at the beginning of the RI process. All assets deployed to the system for the purposes of the RI process will be removed, and the end-user will be notified that the system has not been updated with an appropriate description of the error(s) encountered requiring recovery.

In FIG. 6, one example of different stages of process execution of the local computing entity 106 is shown. Within example usages of the system 100 described herein, the central computing entity 102 executes the service program 154 (and in particular the Scout program) for updating or installing computer software on a group of computer devices. The group may include tens, hundreds, or thousands of computers, and thus, the central computing entity 102 manages and monitors the software changes accordingly. An example benefit of using a sequential software update process in which the Scout program is distributed first followed by distribution of the remote image utility and image file is that after execution of the Scout program on a group of local computing entities, the field monitor 120 receives confirmation signals from each of the local computing entities with status information from which the field monitor 120 generates a list of all computer devices from the group that are candidates for updating. The central computing entity 102 then sends/pushes delivery of the remote image utility and image file accordingly.

Within examples, the software update or installation on the local computing entity 106 can be scheduled and performed offline, such as when the local computing entity 106 are not connected to the network 104. Whether the installation occurs online or offline, the first data package including the Scout program is sent by the central computing entity 102 to the local computing entity 106 within an encrypted data package. Upon receipt, the local computing entity 106 decrypts the encrypted data package using a first encryption technique resulting in a decrypted first data package. Then, the local computing entity 106 encrypts the decrypted first data package using a second encryption technique resulting a re-encrypted first data package for storage on the local computing entity 106. In this manner, the local computing entity 106 has the program stored locally, and can be retrieved and executed at a scheduled time, such as upon receiving from the end user a start signal indicating to execute the first instructions.

In further examples, the central computing entity 102 also sends the remote imaging file and the image file package in an encrypted manner to the local computing entity 106 for decryption and re-encryption by the local computing entity 106 and storage locally on the local computing entity 106 for full offline software update/installation capabilities.

In one example, a first encryption technique includes a public-key cryptography, or asymmetric cryptography, in which pairs of related keys (e.g., public and private keys) are generated with cryptographic algorithms based on mathematical relationships (e.g., one-way functions). An example of the second encryption technique includes a data protection algorithm provided by an existing operating system of the local computing entity 106, such as personal data encryption (PDE) to encrypt individual files.

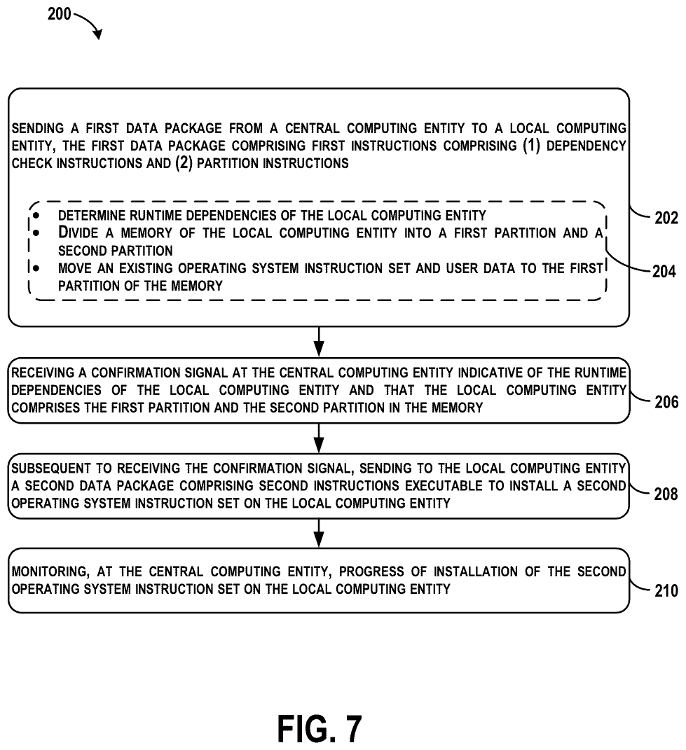

FIG. 7 shows a flowchart of an example of a computer implemented method 200, according to an example implementation. Method 200 shown in FIG. 7 presents an example of a method that could be used with the system 100 shown in FIG. 1, the central computing entity 102, shown in FIG. 1, or the local computing entity 106 shown in FIG. 1, for example. In one example, the functions of method 200 are performed by the central computing entity 102 shown in FIGS. 1-2. Further, devices or systems may be used or configured to perform logical functions presented in FIG. 7. In some instances, components of the devices and/or systems may be configured to perform the functions such that the components are actually configured and structured (with hardware and/or software) to enable such performance. In other examples, components of the devices and/or systems may be arranged to be adapted to, capable of, or suited for performing the functions, such as when operated in a specific manner. Method 200 may include one or more operations, functions, or actions as illustrated by one or more of blocks 202-210. Although the blocks are illustrated in a sequential order, these blocks may also be performed in parallel, and/or in a different order than those described herein. Also, the various blocks may be combined into fewer blocks, divided into additional blocks, and/or removed based upon the desired implementation.

It should be understood that for this and other processes and methods disclosed herein, flowcharts show functionality and operation of one possible implementation of present examples. In this regard, each block or portions of each block may represent a module, a segment, or a portion of program code, which includes one or more instructions executable by a processor for implementing specific logical functions or steps in the process. The program code may be stored on any type of computer readable medium or data storage, for example, such as a storage device including a disk or hard drive. Further, the program code can be encoded on a computer-readable storage media in a machine-readable format, or on other non-transitory media or articles of manufacture. The computer readable medium may include non-transitory computer readable medium or memory, for example, such as computer-readable media that stores data for short periods of time like register memory, processor cache and Random Access Memory (RAM). The computer readable medium may also include non-transitory media, such as secondary or persistent long term storage, like read only memory (ROM), optical or magnetic disks, compact-disc read only memory (CD-ROM), for example. The computer readable media may also be any other volatile or non-volatile storage systems. The computer readable medium may be considered a tangible computer readable storage medium, for example.

In addition, each block or portions of each block in FIG. 7, and within other processes and methods disclosed herein, may represent circuitry that is wired to perform the specific logical functions in the process. Alternative implementations are included within the scope of the examples of the present disclosure in which functions may be executed out of order from that shown or discussed, including substantially concurrent or in reverse order, depending on the functionality involved, as would be understood by those reasonably skilled in the art.

At block 202, the method 200 includes sending a first data package from a central computing entity to a local computing entity, and the first data package comprising first instructions comprising (1) dependency check instructions and (2) partition instructions. As shown at block 204, in examples herein, when the first instructions are executed by a processor of the local computing entity, the processor determines runtime dependencies of the local computing entity, divides a memory of the local computing entity a first partition and a second partition, and moves an existing operating system instruction set and user data to the first partition of the memory.

At block 206, the method 200 includes receiving a confirmation signal at the central computing entity indicative of the runtime dependencies of the local computing entity and that the local computing entity comprises the first partition and the second partition in the memory.

At block 208, the method 200 includes subsequent to receiving the confirmation signal, sending to the local computing entity a second data package comprising second instructions executable to install a second operating system instruction set on the local computing entity.

At block 210, the method 200 includes monitoring, at the central computing entity, progress of installation of the second operating system instruction set on the local computing entity. In one example, functions of block 210 includes during the installation of the second operating system instruction set on the local computing entity, receiving from the local computing entity at the central computing entity messages indicative of progress of the installation of the second operating system instruction set on the local computing entity. Following, in one example, based on receiving from the local computing entity at the central computing entity a failure message, the method 200 includes sending a recovery instruction package from the central computing entity to the local computing entity executable by the local computing entity to return the local computing entity back to the existing operating system instruction set. In another example, based on receiving from the local computing entity at the central computing entity a process execution delay message, the method 200 includes sending a restart signal from the central computing entity to the local computing entity to restart the installation of the second operating system instruction set. In some examples, the central computing entity does not influence restart, but rather, flags the local computing entity for review and/or troubleshooting.

In still another example, in response to not receiving the messages from the local computing entity at the central computing entity within a configurable time period, the method 200 includes sending a restart signal from the central computing entity to the local computing entity to restart the installation of the second operating system instruction set.

In some examples, the application running on the local computing entity 106 is the authoritative processor for deciding how failures will be handled. The central computing entity 102 will receive messages passively. This design ensures that the actions of recovery will take place whether or not outbound communications are possible.

In one example, the second instructions of the second data package comprise (1) installation instructions and (2) the second operating system instruction set, and executing, by the processor of the local computing entity, the installation instructions causes installation of the second operating system instruction set on the local computing entity. Following, the confirmation signal is further indicative of a type of the local computing entity, and the method 200 optionally includes selecting the installation instructions from a group of installation instructions based on the type of local computing entity, and the selected installation instructions comprise an application programming interface (API) for BIOs of the type of the local computing entity.

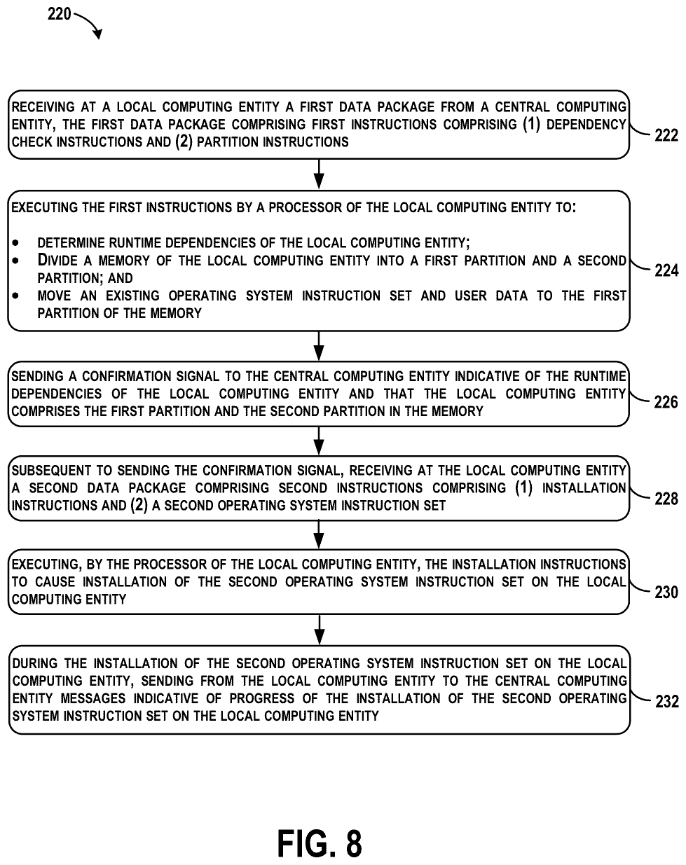

FIG. 8 shows a flowchart of another example of a computer implemented method 220, according to an example implementation. Method 220 shown in FIG. 8 presents an example of a method that could be used with the system 100 shown in FIG. 1, the central computing entity 102, shown in FIG. 1, or the local computing entity 106 shown in FIG. 1, for example. In one example, the functions of method 220 are performed by the local computing entity 106 shown in FIG. 1 and FIG. 3.

At block 222, the method 220 includes receiving at a local computing entity a first data package from a central computing entity, the first data package comprising first instructions comprising (1) dependency check instructions and (2) partition instructions.

At block 224, the method 220 includes executing the first instructions by a processor of the local computing entity to: determine runtime dependencies of the local computing entity; divide a memory of the local computing entity into a first partition and a second partition; and move an existing operating system instruction set and user data to the first partition of the memory. In one example, the first instructions further comprise compatibility instructions, which when executed by the processor of the local computing entity, cause the processor to assess a hardware viability of the local computing entity to identify any defects and check event logs. Following, functions of block 224 optionally include based on the hardware viability of the local computing entity being acceptable, the processor of the local computing entity executing the partition instructions to form the partitions, and move the existing operating system instruction set and user data to the first partition of the memory.

At block 226, the method 220 includes sending a confirmation signal to the central computing entity indicative of the runtime dependencies of the local computing entity and that the local computing entity comprises the first partition and the second partition in the memory.

At block 228, the method 220 includes subsequent to sending the confirmation signal, receiving at the local computing entity a second data package comprising second instructions comprising (1) installation instructions and (2) a second operating system instruction set. In one example, the method 220 further includes upon receiving at the local computing entity the second data package, copying the second operating system instruction set to the first partition of the memory.

At block 230, the method 220 includes executing, by the processor of the local computing entity, the installation instructions to cause installation of the second operating system instruction set on the local computing entity. In one example, functions of block 230 include configuring BIOS of the local computing entity to install the second operating system instruction set on the local computing entity. In another example, functions of block 230 include after completion of the installation of the second operating system instruction set on the local computing entity, moving the user data to the second partition of the memory and remove the division between the first partition and the second partition.

In one example, the partition instructions are further executable to move file system data to the first partition of the memory, and functions of block 230 further include after completion of the installation of the second operating system instruction set on the local computing entity, moving the file system data to the second partition of the memory and remove the partition.

In still another example, functions of block 230 include after completion of the installation of the second operating system instruction set on the local computing entity, moving the second operating system instruction set to the second partition of the memory and removing the division between the first partition and the second partition. However, in other examples, the division between the first partition and the second partition is maintained.

At block 232, the method 220 includes during the installation of the second operating system instruction set on the local computing entity, sending from the local computing entity to the central computing entity messages indicative of progress of the installation of the second operating system instruction set on the local computing entity.

In one example, the method 220 further includes erasing the existing operating system instruction set from the memory of the local computing entity.

In another example, the method 220 further includes causing the local computing entity to be unavailable for use to a user during the installation of the second operating system instruction set.

In yet another example, the first data package comprises an encrypted data package, and the method 220 includes decrypting the encrypted data package at the local computing entity using a first encryption technique resulting in a decrypted first data package, encrypting the decrypted first data package at the local computing entity using a second encryption technique resulting a re-encrypted first data package, and storing the re-encrypted first data package in the memory of the local computing entity. Following, in one example, the method includes receiving from the end user at the local computing entity a start signal indicating to execute the first instructions, and responsively decrypting the re-encrypted first data package for execution.

Within examples herein, systems and methods are described for updating or installing an operating system of the local computing entity 106. However, in other examples, the software to be updated or installed includes software other than an operating system. The software may be an application software, a component of an operating system, a software plug-in, etc.

With reference to FIGS. 2-3, and throughout the disclosure, some components are described as “modules,” and such components include or take a form of a general purpose or special purpose hardware (e.g., general or special purpose processors), firmware, and/or software embodied in a non-transitory computer-readable (storage) medium for execution by one or more processors to perform described functionality.

The description of the different advantageous arrangements has been presented for purposes of illustration and description, and is not intended to be exhaustive or limited to the examples in the form disclosed. Many modifications and variations will be apparent to those of ordinary skill in the art. Further, different advantageous examples may describe different advantages as compared to other advantageous examples. The example or examples selected are chosen and described in order to explain the principles of the examples, the practical application, and to enable others of ordinary skill in the art to understand the disclosure for various examples with various modifications as are suited to the particular use contemplated.

Different examples of the system(s), device(s), and method(s) disclosed herein include a variety of components, features, and functionalities. It should be understood that the various examples of the system(s), device(s), and method(s) disclosed herein may include any of the components, features, and functionalities of any of the other examples of the system(s), device(s), and method(s) disclosed herein in any combination or any sub-combination, and all of such possibilities are intended to be within the scope of the disclosure.

Thus, examples of the present disclosure relate to enumerated clauses (ECs) listed below in any combination or any sub-combination.

EC 1 is a computer-implemented method, the method comprising: sending a first data package from a central computing entity to a local computing entity, the first data package comprising first instructions comprising (1) dependency check instructions and (2) partition instructions, wherein the first instructions, when executed by a processor of the local computing entity, cause the processor to: determine runtime dependencies of the local computing entity; divide a memory of the local computing entity into a first partition and a second partition; and move an existing operating system instruction set and user data to the first partition of the memory; receiving a confirmation signal at the central computing entity indicative of the runtime dependencies of the local computing entity and that the local computing entity comprises the first partition and the second partition in the memory; subsequent to receiving the confirmation signal, sending to the local computing entity a second data package comprising second instructions executable to install a second operating system instruction set on the local computing entity; and monitoring, at the central computing entity, progress of installation of the second operating system instruction set on the local computing entity.

EC 2 is the method of EC 1, wherein: said monitoring of the progress of the installation of the second operating system instruction set on the local computing entity comprises: during the installation of the second operating system instruction set on the local computing entity, receiving from the local computing entity at the central computing entity messages indicative of progress of the installation of the second operating system instruction set on the local computing entity.

EC 3 is the method of any of ECs 1-2, wherein based on receiving from the local computing entity at the central computing entity a failure message: sending a recovery instruction package from the central computing entity to the local computing entity executable by the local computing entity to return the local computing entity back to the existing operating system instruction set. In other examples, the recovery instruction package is embedded in the application package that is delivered.

EC 4 is the method of any of ECs 1-3, wherein based on receiving from the local computing entity at the central computing entity a process execution delay message: sending a restart signal from the central computing entity to the local computing entity to restart the installation of the second operating system instruction set.

EC 5 is the method of any of ECs 1-4, wherein in response to not receiving the messages from the local computing entity at the central computing entity within a configurable time period, sending a restart signal from the central computing entity to the local computing entity to restart the installation of the second operating system instruction set.

EC 6 is the method of any of ECs 1-5, wherein the second instructions of the second data package comprise (1) installation instructions and (2) the second operating system instruction set, wherein executing, by the processor of the local computing entity, the installation instructions causes installation of the second operating system instruction set on the local computing entity, wherein the confirmation signal is further indicative of a type of the local computing entity, and the method further comprises: selecting the installation instructions from a group of installation instructions based on the type of local computing entity, wherein the selected installation instructions comprise an application programming interface (API) for BIOs of the type of the local computing entity.

EC 7 is a computer-implemented method, the method comprising: receiving at a local computing entity a first data package from a central computing entity, the first data package comprising first instructions comprising (1) dependency check instructions and (2) partition instructions; executing the first instructions by a processor of the local computing entity to: determine runtime dependencies of the local computing entity; divide a memory of the local computing entity into a first partition and a second partition; and move an existing operating system instruction set and user data to the first partition of the memory; sending a confirmation signal to the central computing entity indicative of the runtime dependencies of the local computing entity and that the local computing entity comprises the first partition and the second partition in the memory; subsequent to sending the confirmation signal, receiving at the local computing entity a second data package comprising second instructions comprising (1) installation instructions and (2) a second operating system instruction set; executing, by the processor of the local computing entity, the installation instructions to cause installation of the second operating system instruction set on the local computing entity; and during the installation of the second operating system instruction set on the local computing entity, sending from the local computing entity to the central computing entity messages indicative of progress of the installation of the second operating system instruction set on the local computing entity.

EC 8 is the method of EC 7, wherein the first instructions further comprising compatibility instructions, which when executed by the processor of the local computing entity, cause the processor to: assess a hardware viability of the local computing entity to identify any defects and check event logs.

EC 9 is the method of any of ECs 7-8, wherein: based on the hardware viability of the local computing entity being acceptable, the processor of the local computing entity executing the partition instructions to: form the first partition and the second partition; and move the existing operating system instruction set and user data to the first partition of the memory.

EC 10 is the method of any of ECs 7-9, wherein said executing of the installation instructions comprises: configuring BIOS firmware of the local computing entity to install the second operating system instruction set on the local computing entity.

EC 11 is the method of any of ECs 7-10, wherein said executing of the installation instructions comprises: after completion of the installation of the second operating system instruction set on the local computing entity, moving the user data to the second partition of the memory and remove the division between the first partition and the second partition.

EC 12 is the method of any of ECs 7-11, wherein the partition instructions are further executable to move file system data to the first partition of the memory.

EC 13 is the method of any of ECs 7-12, wherein said executing of the installation instructions comprises: after completion of the installation of the second operating system instruction set on the local computing entity, moving the file system data to the second partition of the memory and remove the division between the first partition and the second the partition.

EC 14 is the method of any of ECs 7-13, further comprising: erasing the existing operating system instruction set from the memory of the local computing entity.

EC 15 is the method of any of ECs 7-14, further comprising: upon receiving at the local computing entity the second data package, copying the second operating system instruction set to the first partition of the memory.

EC 16 is the method of any of ECs 7-15, wherein executing, by the processor of the local computing entity, the installation instructions causes installation of the second operating system instruction set on the first partition of the memory on the local computing entity; and after completion of the installation of the second operating system instruction set on the local computing entity, the functions further comprise moving the second operating system instruction set to the second partition of the memory and removing the division between the first partition and the second partition.

EC 17 is the method of any of ECs 7-16, further comprising: causing the local computing entity to be unavailable for use to a user during the installation of the second operating system instruction set.

EC 18 is the method of any of ECs 7-17, wherein the first data package comprises an encrypted data package, and the method further comprises: decrypting the encrypted data package at the local computing entity using a first encryption technique resulting in a decrypted first data package; encrypting the decrypted first data package at the local computing entity using a second encryption technique resulting a re-encrypted first data package; and storing the re-encrypted first data package in the memory of the local computing entity.

EC 19 is the method of any of ECs 7-18, further comprising: receiving from the central computing entity at the local computing entity a start signal indicating to execute the first instructions; and responsively decrypting the re-encrypted first data package for execution.

EC 20 is a non-transitory computer readable medium having stored thereon instructions, that when executed by one or more processors of a local computing entity, cause the local computing entity to perform functions comprising: receiving at the local computing entity a first data package from a central computing entity, the first data package comprising first instructions comprising (1) dependency check instructions and (2) partition instructions; executing the first instructions by the processor of the local computing entity to: determine runtime dependencies of the local computing entity; divide a memory of the local computing entity into a first partition and a second partition; and move an existing operating system instruction set and user data to the first partition of the memory; sending a confirmation signal to the central computing entity indicative of the runtime dependencies of the local computing entity and that the local computing entity comprises the first partition and the second partition in the memory; subsequent to sending the confirmation signal, receiving at the local computing entity a second data package comprising second instructions comprising (1) installation instructions and (2) a second operating system instruction set; executing, by the processor of the local computing entity, the installation instructions to cause installation of the second operating system instruction set on the local computing entity; and during the installation of the second operating system instruction set on the local computing entity, sending from the local computing entity to the central computing entity messages indicative of progress of the installation of the second operating system instruction set on the local computing entity.

By the term “substantially” and “about” used herein, it is meant that the recited characteristic, parameter, or value need not be achieved exactly, but that deviations or variations, including for example, tolerances, measurement error, measurement accuracy limitations and other factors known to skill in the art, may occur in amounts that do not preclude the effect the characteristic was intended to provide. The terms “substantially” and “about” represent the inherent degree of uncertainty that may be attributed to any quantitative comparison, value, measurement, or other representation. The terms “substantially” and “about” are also utilized herein to represent the degree by which a quantitative representation may vary from a stated reference without resulting in a change in the basic function of the subject matter at issue.

It is noted that one or more of the following claims utilize the term “wherein” as a transitional phrase. For the purposes of defining the present invention, it is noted that this term is introduced in the claims as an open-ended transitional phrase that is used to introduce a recitation of a series of characteristics of the structure and should be interpreted in like manner as the more commonly used open-ended preamble term “comprising.”

What is claimed is:

1. A computer implemented method, the method comprising:
sending a first data package from a central computing entity to a local computing entity, the first data package comprising first instructions comprising (1) dependency check instructions and (2) partition instructions, wherein the first instructions, when executed by a processor of the local computing entity, cause the processor to:
determine runtime dependencies of the local computing entity;
divide a memory of the local computing entity into a first partition and a second partition; and
move an existing operating system instruction set and user data to the first partition of the memory;
receiving a confirmation signal at the central computing entity indicative of the runtime dependencies of the local computing entity and that the local computing entity comprises the first partition and the second partition in the memory;
subsequent to receiving the confirmation signal, sending to the local computing entity a second data package comprising second instructions executable to install a second operating system instruction set on the local computing entity; and
monitoring, at the central computing entity, progress of installation of the second operating system instruction set on the local computing entity.

2. The method of claim 1, wherein said monitoring of the progress of the installation of the second operating system instruction set on the local computing entity comprises:
during the installation of the second operating system instruction set on the local computing entity, receiving from the local computing entity at the central computing entity messages indicative of progress of the installation of the second operating system instruction set on the local computing entity.

3. The method of claim 2, wherein based on receiving from the local computing entity at the central computing entity a failure message:
sending a recovery instruction package from the central computing entity to the local computing entity executable by the local computing entity to return the local computing entity back to the existing operating system instruction set.

4. The method of claim 2, wherein based on receiving from the local computing entity at the central computing entity a process execution delay message:
sending a restart signal from the central computing entity to the local computing entity to restart the installation of the second operating system instruction set.

5. The method of claim 2, wherein in response to not receiving the messages from the local computing entity at the central computing entity within a configurable time period,
sending a restart signal from the central computing entity to the local computing entity to restart the installation of the second operating system instruction set.

6. The method of claim 1, wherein the second instructions of the second data package comprise (1) installation instructions and (2) the second operating system instruction set, wherein executing, by the processor of the local computing entity, the installation instructions causes installation of the second operating system instruction set on the local computing entity, wherein the confirmation signal is further indicative of a type of the local computing entity, and the method further comprises:
selecting the installation instructions from a group of installation instructions based on the type of local computing entity, wherein the selected installation instructions comprise an application programming interface (API) for BIOs of the type of the local computing entity.

7. A computer implemented method, the method comprising:
receiving at a local computing entity a first data package from a central computing entity, the first data package comprising first instructions comprising (1) dependency check instructions and (2) partition instructions;
executing the first instructions by a processor of the local computing entity to:
determine runtime dependencies of the local computing entity;
dividing a memory of the local computing entity into a first partition and a second partition; and
move an existing operating system instruction set and user data to the first partition of the memory;
sending a confirmation signal to the central computing entity indicative of the runtime dependencies of the local computing entity and that the local computing entity comprises the first partition and the second partition in the memory;
subsequent to sending the confirmation signal, receiving at the local computing entity a second data package comprising second instructions comprising (1) installation instructions and (2) a second operating system instruction set;
executing, by the processor of the local computing entity, the installation instructions to cause installation of the second operating system instruction set on the local computing entity; and
during the installation of the second operating system instruction set on the local computing entity, sending from the local computing entity to the central computing entity messages indicative of progress of the installation of the second operating system instruction set on the local computing entity.

8. The method of claim 7, wherein the first instructions further comprising compatibility instructions, which when executed by the processor of the local computing entity, cause the processor to:
assess a hardware viability of the local computing entity to identify any defects and check event logs.

9. The method of claim 8, wherein:
based on the hardware viability of the local computing entity being acceptable, the processor of the local computing entity executing the partition instructions to:
form the first partition and the second partition; and
move the existing operating system instruction set and user data to the first partition of the memory.

10. The method of claim 7, wherein said executing of the installation instructions comprises:
configuring BIOS firmware of the local computing entity to install the second operating system instruction set on the local computing entity.

11. The method of claim 7, wherein said executing of the installation instructions comprises:
after completion of the installation of the second operating system instruction set on the local computing entity, moving the user data to the second partition of the memory and remove the division between the first partition and the second partition.

12. The method of claim 7, wherein the partition instructions are further executable to move file system data to the first partition of the memory.

13. The method of claim 12, wherein said executing of the installation instructions comprises:
after completion of the installation of the second operating system instruction set on the local computing entity, moving the file system data to the second partition of the memory and remove the division between the first partition and the second partition.

14. The method of claim 7, further comprising:
erasing the existing operating system instruction set from the memory of the local computing entity.

15. The method of claim 7, further comprising:
upon receiving at the local computing entity the second data package, copying the second operating system instruction set to the first partition of the memory.

16. The method of claim 7, wherein executing, by the processor of the local computing entity, the installation instructions causes installation of the second operating system instruction set on the first partition of the memory on the local computing entity; and
after completion of the installation of the second operating system instruction set on the local computing entity, the functions further comprise moving the second operating system instruction set to the second partition of the memory and removing the division between the first partition and the second partition.

17. The method of claim 7, further comprising:
causing the local computing entity to be unavailable for use to a user during the installation of the second operating system instruction set.

18. The method of claim 7, wherein the first data package comprises an encrypted data package, and the method further comprises:
decrypting the encrypted data package at the local computing entity using a first encryption technique resulting in a decrypted first data package;
encrypting the decrypted first data package at the local computing entity using a second encryption technique resulting a re-encrypted first data package; and
storing the re-encrypted first data package in the memory of the local computing entity.

19. The method of claim 18, further comprising:
receiving from the central computing entity at the local computing entity a start signal indicating to execute the first instructions; and
responsively decrypting the re-encrypted first data package for execution.

20. A non-transitory computer readable medium having stored thereon instructions, that when executed by one or more processors of a local computing entity, cause the local computing entity to perform functions comprising:
receiving at the local computing entity a first data package from a central computing entity, the first data package comprising first instructions comprising (1) dependency check instructions and (2) partition instructions;
executing the first instructions by the processor of the local computing entity to:
determine runtime dependencies of the local computing entity;
divide a memory of the local computing entity into a first partition and a second partition; and
move an existing operating system instruction set and user data to the first partition of the memory;
sending a confirmation signal to the central computing entity indicative of the runtime dependencies of the local computing entity and that the local computing entity comprises the first partition and the second partition in the memory;
subsequent to sending the confirmation signal, receiving at the local computing entity a second data package comprising second instructions comprising (1) installation instructions and (2) a second operating system instruction set;
executing, by the processor of the local computing entity, the installation instructions to cause installation of the second operating system instruction set on the local computing entity; and
during the installation of the second operating system instruction set on the local computing entity, sending from the local computing entity to the central computing entity messages indicative of progress of the installation of the second operating system instruction set on the local computing entity.
